(19) United States
(12) Patent Application Publication
(10) Pub. No.: US 2021/0015056 A1
(43) Pub. Date: Jan. 21, 2021

(54) Aeration and Irrigation Apparatus for Plants and Seeds

(71) Applicant: Jeffery Charles Main, Troutdale, OR (US)

(72) Inventor: Jeffery Charles Main, Troutdale, OR (US)

(21) Appl. No.: 16/783,941

(22) Filed: Feb. 6, 2020

Related U.S. Application Data
(60) Provisional application No. 62/875,393, filed on Jul. 17, 2019.

(51) Int. Cl. A01G 27/06; A01G 9/24; A01G 9/02; A01G 27/00; A01G 29/00

(52) U.S. Cl. CPC A01G 27/06; A01G 9/247; A01G 29/00; A01G 27/001; A01G 9/02

(57) ABSTRACT

Air dispersing member adapted for use buried in soil and comprising annular portions defining a hollow annular member comprising an air flow conduit, there being a plurality of holes communicating between the air flow conduit to a location exterior of the hollow annular member for aerating soil, the air dispensing member preferably being combined with an irrigation system for providing an optimal amount of water to a plant or seed, comprising an inner pot having a porous bottom portion and adapted for containing soil for hosting the plant or seed, an outer pot adapted for containing a certain water level, the inner pot and the outer pot together defining a partially enclosed space, an inlet water pipe, an outlet water pipe, and a wicking pad adapted to be in fluid communication between water in the bottom portion of the outer pot and the porous bottom portion of the inner pot.

### CONTINUITY AND CLAIM OF PRIORITY

This U.S. non-provisional patent application claims priority and the benefit of U.S. Provisional Patent Application No. 62/875,393, to Jeffery Charles Main, for “Modular Underground Irrigation and Aeration System” filed on 17 Jul. 2019.

### FIELD

The present invention relates to aeration devices and irrigation systems for stimulating root and plant growth in the agricultural and horticultural arts, and more particularly to an aeration device and irrigation system, preferably combined, comprising a pressurized air dispersing device located partially under soil and usable together with an irrigation system, adaptable to be used to stimulate root and plant growth in one potted plant location, or modularly to stimulate root and plant growth for a plurality of potted plant locations.

### BACKGROUND

To keep pace with growing world population, food production for the world must grow substantially. The Food and Agricultural Organization of the United Nations (FAO) forecasts that global food production will need to increase on the order of 70% if the population reaches 90.1 billion by 2050. Such increased demand for food requires efficient plant growth and horticulture development processes, including improved irrigation systems.

Typically, agricultural irrigation systems are configured to carry water and nutrients to the soil in which plants are to grow, and mainly to the root system of plants and vegetation, providing a predetermined amount of air and moisture necessary for optimum plant growth and development. Common forms of irrigation include gravity flow, flood irrigation, sprinkler irrigation, and drip irrigation.

In soil-based plant growth systems, there have been issues with over or under watering of plants. If a plant's root system receives too much moisture, the plant cannot breathe, and it will die because of lack of oxygen and root rot. Thus, there is needed an ideal ratio of fresh air and water to a plant's root system for the plant to thrive and avoid root rot.

Further, often, water has been wasted, whether in traditional soil-based plant growth systems, and also with hydroponic systems. Thus, there has been needed a system which not only provides an ideal ratio of fresh air and water to a plant's root system, but there is also needed a system which avoids water waste.

To address such issues, prior art systems such as that described in U.S. Pat. No. 4,057,933, to Enyeart, for Apparatus For Aerating Comminuted Matter Such As Soil, have provided that moist air is injected into the root system of plant life to provide moisture proximate plant nodules of the root system to foster growth. Enyeart teaches that the water vapor introduced into the root system may be warmed and/or evaporated, and in fields and grounds use, perforate conduit may be connected to a source of pressurized air, water vapor, or other gases for the purpose of conditioning the fields and ground, either to remove moisture or to add moisture to plant life beneath, at, or even above the soil surface. Enyeart teaches that the root system of trees may also be conditioned for regulating, relatively exactly, growth and dormant states.

Hydroponic systems have been developed comprising a system of growing plants with their root systems suspended in liquid water, with nutrients added to the water, and without soil. One problem associated with hydroponics is that, unless fresh water is cycled through the system approximately weekly, root rot may result. Further, of course, hydroponic systems have required added nutrients which otherwise may be available in fertile soil.

Generally, healthy plants need water, air, and nutrition to survive. Accordingly, there is needed a system which provides a copious, uniform supply of water, and an appropriate air supply to the root system.

### SUMMARY

In accordance with one or more aspects of the disclosure, there is provided an air dispersing member adapted for use buried in soil with an irrigation system, comprising: a hollow annular member comprising an upper annular portion, a lower annular portion, an outer annular portion, and an inner annular portion, the annular portions defining an air flow conduit within the hollow annular member, wherein at least one of the annular portions have defined therein a plurality of holes communicating between the air flow conduit to a location exterior of the hollow annular member, the hollow annular member thus being adapted to allow the passage of air into soil in which the air dispersing member has been buried by a user for aerating the soil.

Preferably the hollow annular member of this aspect of the disclosure is generally torus shaped. Thus, the upper annular portion, the inner annular portion, the outer annular portion, and the inner annular portion, are each preferably generally curved in shape, and the annular portions are combined to form the generally torus-shaped air dispersing member. Further, in an embodiment of the air dispersing member, the upper annular portion comprises a flat upper surface, the inner annular portion comprises a curved inner surface, the outer annular portion comprises a curved outer surface, and the lower annular portion comprises a flat lower surface. Accordingly, the annular portions of this embodiment are combined to form a conduit that is stadium shaped in cross-section.

In accordance with another aspect of the disclosure, there are provided a plurality of hollow annular members, each hollow annular member comprising an upper annular portion, a lower annular portion, an outer annular portion, and an inner annular portion, each hollow annular member having defined therein a plurality of holes communicating between the air flow conduit to a location exterior of each the hollow annular member, each hollow annular member thus being further adapted to allow the passage of air into soil more closely adjacent plant roots for aerating soil and plant roots. Preferably in accordance with this aspect of the disclosure, each upper annular portion, each inner annular portion, each outer annular portion, and each lower annular portion, have defined therein a plurality of holes communicating between the air flow conduit to a location exterior of the hollow annular member. Thus, each hollow annular member is adapted to allow the passage of air into soil more closely adjacent plant roots.

In accordance with another aspect of the disclosure, the air dispersing member of another aspect of the disclosure further comprises an inlet airline connected to supply pressurized air from a source to the hollow annular member via one of the plurality of holes of the hollow annular member. Further, in accordance with this aspect of the disclosure, there is provided an air flow control device in line with the inlet airline. In accordance with an aspect of the disclosure, each of the plurality of air dispersing members further comprises an inlet airline connected via one of the plurality of holes of each hollow annular member, each hollow annular member being adapted for being employed in a corresponding plurality of soil locations and interconnected with a preferably common pressurized air supply via each inlet airline.

In accordance with another aspect of the disclosure, there is provided an irrigation system, or an irrigation pod, for providing an optimal amount of water to potted plants, comprising: an inner pot having a porous bottom portion and adapted for containing soil for hosting a plant or seed and an outer pot adapted for containing water to a certain water level in a bottom portion of the outer pot, the inner pot adapted for residing partially nested in an upper portion of the outer pot, the inner pot and the outer pot together defining an at least partially enclosed space between the bottom portion of the inner pot and a bottom portion of the outer pot. In this embodiment, the bottom portion of the inner pot is adapted for being located above the water level adapted to be retained in the bottom portion of the outer pot.

Further, the irrigation system in accordance with this aspect of the disclosure further comprises an inlet water pipe and an outlet water pipe in sealed communication with the bottom portion of the outer pot adapted for controlling the water level in the bottom portion of the outer pot. And still further, there is provided at least one wicking pad adapted to be in fluid communication between water in the bottom portion of the outer pot and the porous bottom portion of the inner pot. In an embodiment, the inner pot may nest within an upper portion of the outer pot, with the inner pot resting on top of the wicking pad, or pads.

In an embodiment, the inner pot and the outer pots of the irrigation system in accordance with this aspect of the disclosure further comprises a detachable fastening system for releasably interconnecting the inner pot and the outer pot. This detachable fastening system preferably comprises an upper rim portion on the inner pot, the upper rim portion having a retaining portion and a receptacle portion, and an upper flange portion on the outer pot, the upper flange portion being adapted to be received and retained in the receptacle portion of the inner pot at one relative rotation orientation between the inner pot and the outer pot. Thus, the detachable fastening system for interconnecting the inner pot and the outer pot provides that the upper flange portion is retained in the retaining portion of the upper rim portion of the inner pot when the outer pot is twisted relative to the inner pot, when the upper rim portion and the upper flange portion of the pots are engaged.

In accordance with another aspect of the disclosure, there are provided a plurality of irrigation systems, each irrigation system adapted to be interconnected, or interconnected, to another irrigation system with at least the inlet water pipe or the outlet water pipe, for providing an optimal amount of water to a plurality of potted plants. Still further in accordance with this aspect of the disclosure, the plurality of irrigation systems further comprises an inlet valve on each inlet water pipe and an outlet valve on each outlet water pipe of each irrigation system, wherein at least one of the inlet water pipes is detachable from a water supply upline from at least one of the inlet valves, and wherein at least one of the outlet water pipes is detachable from a water outlet system downline from at least one of the outlet valves, to enable transport, relocation, and subsequent interconnection of the irrigation system to another location part of the same water supply and water outlet system or another water supply and water outlet system, all adaptable to such relocation in a manner that water is not wasted during the relocation.

In accordance with another aspect of the disclosure, there is provided a combination modular aeration and irrigation system, or pod, adapted for providing an optimal amount of air and water to, and facilitating growth of, a potted plant, comprising: an air dispersing member further comprising a hollow annular member comprising an upper annular portion, a lower annular portion, an outer annular portion, and an inner annular portion. The annular portions define an air flow conduit within the hollow annular member, and at least one of the annular portions have defined therein a plurality of holes communicating between the air flow conduit to a location exterior of the hollow annular member. In this manner, the hollow annular member is adapted to allow the passage of air into soil in which the air dispersing member has been buried by a user for aerating the soil.

In accordance with this aspect of the disclosure, there is further provided an inlet airline connected to one of the plurality of holes of the hollow annular member adapted to supply pressurized air from a source to the air dispersing member. This enables passage of air into soil in which the air dispersing member has been buried by a user for aerating the soil. Still further, in accordance with this aspect of the disclosure, there is provided an air flow control device inline with the inlet airline.

The combination modular aeration and irrigation system in accordance with this aspect of the disclosure further comprises an inner pot having a porous bottom portion, adapted for containing soil for hosting a plant or seed, and an outer pot adapted for containing water to a certain water level in a bottom portion of the outer pot. The inner pot of this aspect of the disclosure is adapted for residing partially nested in an upper portion of the outer pot, the inner pot and the outer pot together defining a closed space between the bottom portion of the inner pot and a bottom portion of the outer pot, with the bottom portion of the inner pot adapted for being located above a water level adapted to be retained in the bottom portion of the outer pot.

This aspect and embodiment of the disclosure further comprises an inlet water pipe and an outlet water pipe in sealed communication with the bottom portion of the outer pot, adapted for controlling the water level in the bottom portion of the outer pot. And further, in accordance with this aspect and embodiment of the disclosure, there is provided at least one wicking pad adapted to be in fluid communication between water in the bottom portion of the outer pot and the porous bottom portion of the inner pot for wicking water from the outer pot to a seed or plant in soil in the inner pot. Thus, in this embodiment, the inner pot would rest on the wicking pad retained at the bottom of the outer pot.

Further in accordance with this aspect of the disclosure, the combination modular aeration and irrigation system is provided wherein each of the plurality of the annular portions of the hollow annular member have defined therein a plurality of holes communicating between the air flow conduit to a location exterior of the hollow annular member. Thus, the hollow annular member of this aspect and embodiment of the disclosure is further adapted to allow the passage of air into soil in which the air dispersing member has been buried by a user more closely adjacent plant roots for aerating the soil and plant roots. Thus, preferably, the combination modular aeration and irrigation system is provided, wherein each upper annular portion, each inner annular portion, each outer annular portion, and each lower annular portion have defined therein a plurality of holes communicating between the air flow conduit to a location exterior of the hollow annular member. Thus, the hollow annular member of this aspect and embodiment of the disclosure is further adapted to allow the passage of air into soil in which the air dispersing member has been buried by a user more closely adjacent plant roots for aerating the soil and plant roots.

The combination modular aeration and irrigation system of this aspect and embodiment of the disclosure may further comprise a detachable fastening system for releasably interconnecting the inner pot and the outer pot. Further, preferably, such a detachable fastening system comprises an upper rim portion on the inner pot, the upper rim portion having a retaining portion and a receptacle portion, and an upper flange portion on the outer pot. In accordance with this aspect and embodiment of the disclosure, the upper flange portion is adapted to be received and retained in the receptacle portion of the inner pot at one relative rotation orientation between the inner pot and the outer pot, and the upper flange portion is retained in the retaining portion of the upper rim portion of the inner pot when the outer pot is twisted relative to the inner pot with the upper rim portion and the upper flange portion being engaged.

In accordance with another aspect of the disclosure, there are provided a plurality of combination modular aeration and irrigation systems interconnected to each other for providing an optimal amount of water and aeration to a plurality of potted plants. This aspect of the disclosure provides a plurality of air dispersing members further comprising a corresponding plurality of hollow annular members, each hollow annular member comprising an upper annular portion, a lower annular portion, an outer annular portion, and an inner annular portion. These annular portions define a plurality of air flow conduits, each air flow conduit residing within a corresponding hollow annular member, wherein at least one of each hollow annular member has defined therein a plurality of holes communicating between the airflow conduit to a location exterior of each hollow annular member. Thus, each hollow annular member in accordance with this aspect of the disclosure is adapted to allow the passage of air into soil in which each air dispersing member has been buried by a user for aerating the soil.

The plurality of combination modular aeration and irrigation systems in accordance with this aspect of the disclosure further comprises a plurality of inlet airlines, each inlet airline connected to one of the plurality of holes of each hollow annular member, and adapted to supply pressurized air from a source to each air dispersing member, there being further provided an air flow control device in line with the plurality of inlet airlines.

The plurality of combination modular aeration and irrigation systems in accordance with this aspect of the disclosure further comprises a plurality of inner pots, each inner pot having a porous bottom portion adapted for containing soil for hosting a plant or seed, each hollow annular member adapted for being buried in soil in one of a corresponding plurality of inner pots. The plurality of systems in accordance with this aspect of the disclosure further comprises a plurality of outer pots, each outer pot adapted for containing water to a certain water level in a bottom portion of each outer pot, each inner pot adapted for residing in one of a corresponding outer pot, each inner pot and corresponding outer pot adapted for residing partially nested together defining an at least partially enclosed space between the bottom portion of each inner pot and a bottom portion of each outer pot.

The plurality of combination modular aeration and irrigation systems in accordance with this aspect of the disclosure further comprises a plurality of wicking pads, each wicking pad adapted to be in fluid communication between water in the bottom portion of each outer pot and the porous bottom portion of each corresponding inner pot. Further, in accordance with this aspect of the disclosure, there are provided a plurality of inlet water pipes connected to each the of the plurality of outer pots, at least one of the inlet water pipes having an inlet valve, and at least one outlet water pipe connected to one of the plurality of outer pots, the at least one outlet water pipe having an outlet valve. Further, at least one of the plurality of inlet water pipes is detachable from a water supply line, and the at least one outlet water pipe is detachable from a water outlet system downline from the outlet valve. This is to enable transport, relocation, and subsequent interconnection of the plurality of combination modular aeration and irrigation systems to another location part of the same water supply and water outlet system, or to another water supply and water outlet system, all in a manner that water is not wasted during the relocation.

Preferably, the plurality of combination modular aeration and irrigation systems in accordance with this aspect of the disclosure provides that each inner pot and corresponding outer pot further comprises a detachable fastening system for releasably interconnecting each inner pot and corresponding outer pot. Preferably, each detachable fastening system comprises an upper rim portion on each inner pot, each upper rim portion having a retaining portion and a receptacle portion, and an upper flange portion on each outer pot. Accordingly, each upper flange portion of each outer pot is adapted to be received and retained in the receptacle portion of each corresponding inner pot at a relative rotation orientation between each inner pot and each corresponding outer pot. Thus, in accordance with this aspect and embodiment of the disclosure, each upper flange portion of each outer pot is retained in the retaining portion of each corresponding upper rim portion of each corresponding inner pot, when each outer pot is twisted relative to its corresponding inner pot with each upper rim portion and each corresponding upper flange portion engaged.

Thus, the present disclosure is for an aeration device and an aeration and irrigation system, some of the components of which are preferably located underneath soil, which is estimated to expedite food production by 35% to 50% or higher in a soil-based system, as opposed to a traditionally hydroponic system. With such irrigated soil, it is possible to use less additive nutrition because the soil has its own nutrition.

The aeration feature aspect of the present aeration and irrigation system delivers fresh air to the plant's root system even if the soil is too wet for the plant to survive under normal conditions. This can also be effective for reducing root rot.

And because the present invention is a soil-based system, a nutritional value is applied to the plants. This makes the plant grow healthier and quicker than other organic plant growth and irrigation systems known in the prior art.

The subject matter of the present disclosure is particularly pointed out and distinctly claimed in the concluding portion of this specification. However, both the organization and method of operation, together with further advantages and objects thereof, may best be understood by reference to the following descriptions taken in connection with accompanying drawings wherein like reference characters refer to like elements.

### BRIEF DESCRIPTIONS OF DRAWINGS

The present disclosure, in accordance with one or more aspects and various embodiments, is described in detail with reference to the following figures. The drawings are provided for purposes of illustration and they depict typical or example embodiments of a device and system claimed at the end of the present disclosure. The drawings are provided to facilitate the reader's understanding of the device and system in accordance with the present disclosure and shall not be considered limiting of the breadth, scope, or applicability of the device and system as claimed. It should also be noted that for clarity and ease of illustration the drawings are not necessarily made to scale.

FIG. 1 is an illustration of a top view of an exemplary combined modular irrigation and aeration system in accordance with an aspect and embodiment of the present disclosure;

FIG. 2A is a closeup view of an outer rim of an outer pot interlocked with an inner pot, the detailed section taken from B in FIG. 3, in accordance with an aspect and embodiment of the present disclosure;

FIG. 2B is a closeup representative view of an exemplary interlock pattern for the outer pot and inner pot shown in FIG. 2A;

FIG. 3 is a sectioned side view of an exemplary combined modular irrigation and aeration system, or pod, showing soil packed into an inner pot having an air dispersing member buried therein, and with valves for regulating water flowage into the bottom portion of the outer pot, in accordance with one or more aspects and an embodiment of the present disclosure;

FIG. 4 is a top view of an outer pot and water inlet portions (also shown in FIG. 5) of an irrigation system, not having an interlock system as shown in FIG. 2B, and adapted to be combined, optionally, with an aeration system as shown in FIGS. 1, 3 and 12, and in accordance with an aspect and embodiment of the present disclosure;

FIG. 5 is a sectioned side view of the outer pot, with an interlock system as shown in FIG. 2B, and water inlet portions of the irrigation system shown in FIGS. 3 and 4, the section taken along C-C of FIG. 4, detailing the outer pot and valves for water flowage in accordance with an aspect and embodiment of the present disclosure;

FIG. 6 is a perspective view of an exemplary perforated air dispersing member, or manifold, and inlet airline, in accordance with an aspect and embodiment of the present disclosure;

FIG. 7 is a top view of an exemplary perforated air dispersing member in accordance with an aspect and embodiment of the present disclosure;

FIG. 8 is a sectioned side view of the perforated air dispersing member shown in FIG. 6, the section taken along F-F of FIG. 9, detailing the hollow interior section of the air dispersing member and in accordance with an aspect and embodiment of the present disclosure;

FIG. 9 is a side view of the perforated air dispersing member shown in FIG. 6 in accordance with an embodiment of the present disclosure;

FIG. 10 is a bottom section view of the perforated air dispersing member shown in FIG. 6, the section taken along D-D of FIG. 9, detailing the interior of the air distribution member and in accordance with an aspect and embodiment of the present disclosure;

FIG. 11A is a side view of an alternate embodiment of an air dispersing member in accordance with an aspect and embodiment of the present disclosure;

FIG. 11B is a sectioned side view of the perforated air dispersing member shown in FIG. 11A, the section taken along G-G of FIG. 11A, detailing the hollow interior section of the alternative air dispersing member and in accordance with an aspect and embodiment of the present disclosure;

FIG. 12 is a plan view illustration of an example aeration and irrigation system comprising a plurality of modular aeration and irrigation subsystems, or pods, some with and some without interlocked pots; and

FIG. 13 is a plan view illustration of an alternate example aeration and irrigation system comprising a modular aeration subsystem with a partially modular irrigation subsystem.

### DETAILED DESCRIPTION

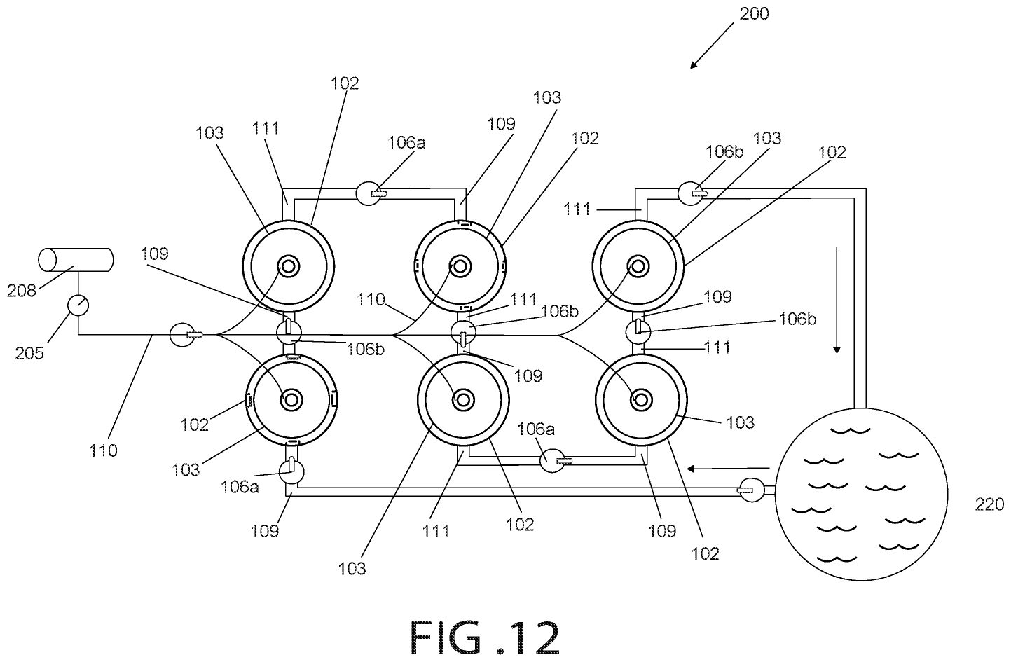

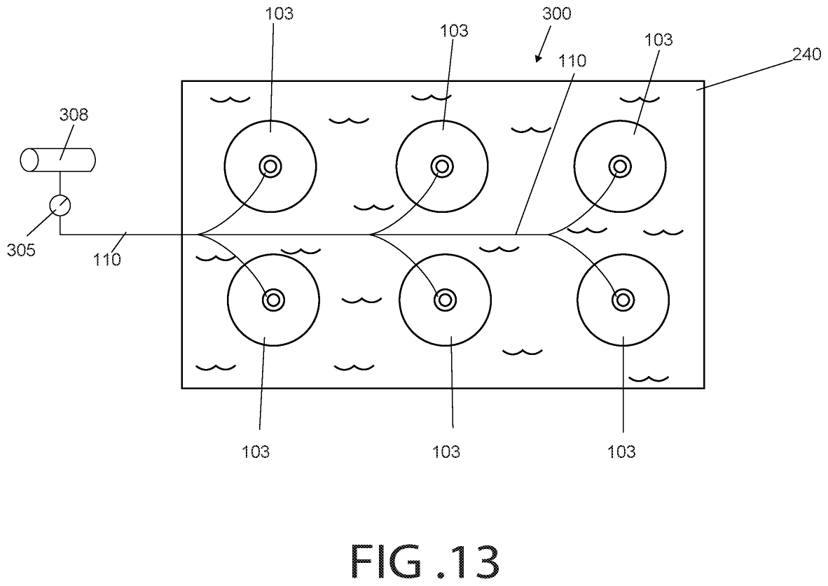

Various aspects of the claimed aeration and irrigation apparatus system 100 hereof are capable of use in multiple different environments, whether in potted soil, in a greenhouse operation, in an open field, or other environment. However, other aspects of the disclosure, such as for a plurality of combined aeration and irrigation modular devices 200, 300 (see FIGS. 12 and 13), may be better suited for potted plant-type operations. Nevertheless, the various features and embodiments hereof are disclosed as to exemplary applications. After reading this disclosure, it will become apparent to those of ordinary skill in the art how the various aspects of the invention may be implemented in various different, and alternative, environments, such as for example in a greenhouse, in a potted plant scenario, in raised beds, in an open plot, in an open field (farm), with just the aeration subsystem in a non-potted plant environment, with just the irrigation subsystem, or with just a portion of the irrigation subsystem.

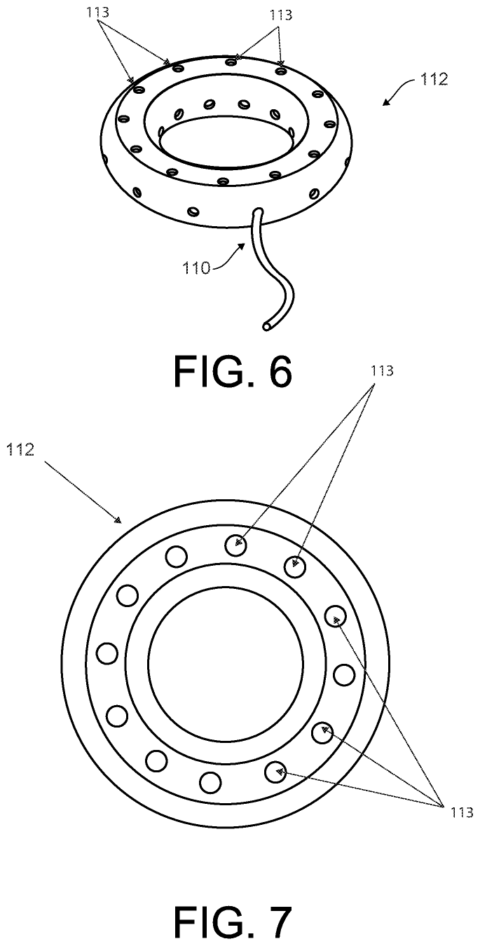

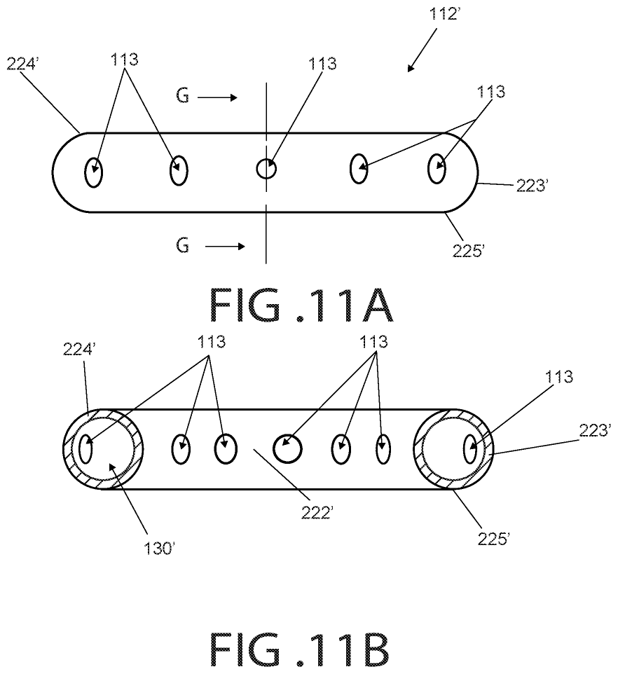

Referring to FIGS. 6-10, the present disclosure is directed towards a novel air dispersing device, otherwise known as an air distribution member, 112 with perforations, or holes, 113, and referring to FIGS. 11A and 11B, the present disclosure is also directed towards an alternate novel air dispersing device 112′ with such perforations, or holes, 113. Each air dispersing device 112, 112′ is adapted for use with an aeration system for plants, or seeds, whether they be potted, in a greenhouse or outside, or planted in an open plot or field.

The aeration system further comprises an air pump, or compressor, 108, and an airline, or air tube, 110 attached to the air dispersing device 112, 112′ at the location of a hole 113 or other perforation specifically designed to interconnect the airline. The air dispersing device 112, 112′ is designed to be buried, or partially buried, in the soil near the roots of a plant or closely adjacent a seed to be germinated and started. The airline 110 that is in communication with the air pump 108 feeds air, and hence oxygen, into the region of a pot containing soil or other area of soil surrounding plant roots or seeds.

Thus, the aeration subsystem supplies air/oxygen for aerating soil and roots, whether the air dispersing device 112, 112′ is buried in soil in a pot, in a greenhouse, in a garden patch, or in an open field. The air pump, or fan, 108 may include air pumped, drawn (such as a vacuum), or blown (such as a fan) into it to distribute air into the soil. The air pump, or fan, 108 may be fabricated out of a material that will not outgas or leach into the plant roots.

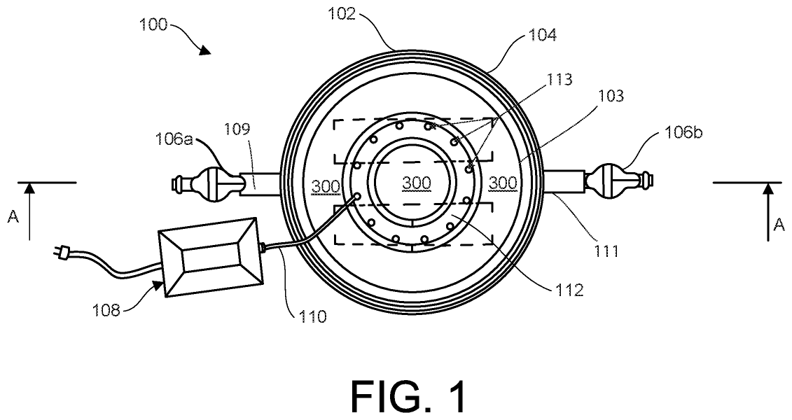

As shown in FIGS. 1, 3, 6, 7-9, 10, 11A, and 11B, the air dispersing devices 112, 112′ each comprise multiple apertures that are in communication with an air channel 130, 130′ within the air dispersing device and which may be connected with an air supply airline 110 leading from the air pump, or fan, 108. The unique shape and position of the air dispersing device 112, 112′ in the soil allows the air dispersing device to uniformly disperse air throughout the soil.

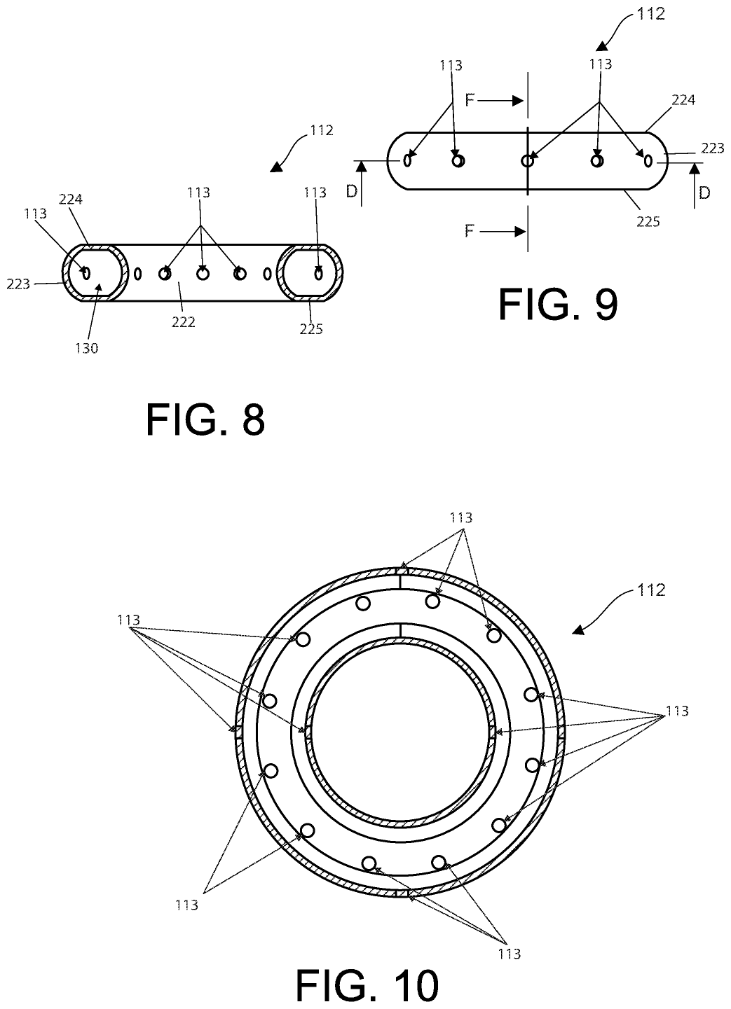

In the embodiment shown in FIGS. 8 and 9, as well as the embodiment shown in FIGS. 11A and 11B, the air dispersing members 112, 112′ each preferably comprise a plastic injection mold having halves, bifurcated and detachably attached together to form a concave profile. The halves can be attached through sonic welding, snap features, glue, or fasteners. Suitable materials for the air dispersing devices 112, 112′ may include, without limitation, a food grade material such as polypropylene.

In an embodiment, the air dispersing device 112, 112′ and associated system otherwise known as a root fan, is preferably connected to an air supply (either positive pressure, a negative vacuum pressure, or blown in as with a fan), and the airline 110 supplying the air dispersing device may enter the outer pot 102 near the top rim 107, thus making the system more modular and more easily transportable to another location to be re-connected with an air compressor or fan 108. The air dispersing device 112, 112′ is buried so that about ½″-1″ of soil is over the top of the air dispersing device. The plant is then placed in the soil adjacent or above the air dispersing device 112, 112′. The plant may then be watered from atop, or directly from the reservoir 123.

With a modular aeration and irrigation system 100, 200, 300 in accordance with one or more aspects of the disclosure, the soil around plant roots or seeds is aerated from within, creating a fluffy, porous soil. Thus, the perforated air dispersing device 112, 112′ delivers fresh air to a plant's root systems, even if the soil is too wet for the plants to survive under normal conditions. This ingress of air allows the air dispersing devices 112, 112′ to uniformly create a positive oxygen flow in the soil by creating a void in the soil with the blown air, and this in turn uniformly distributes fresh air at or near the roots. Thus, the air dispersing devices 112, 112′ may help prevent root rot in overly saturated conditions.

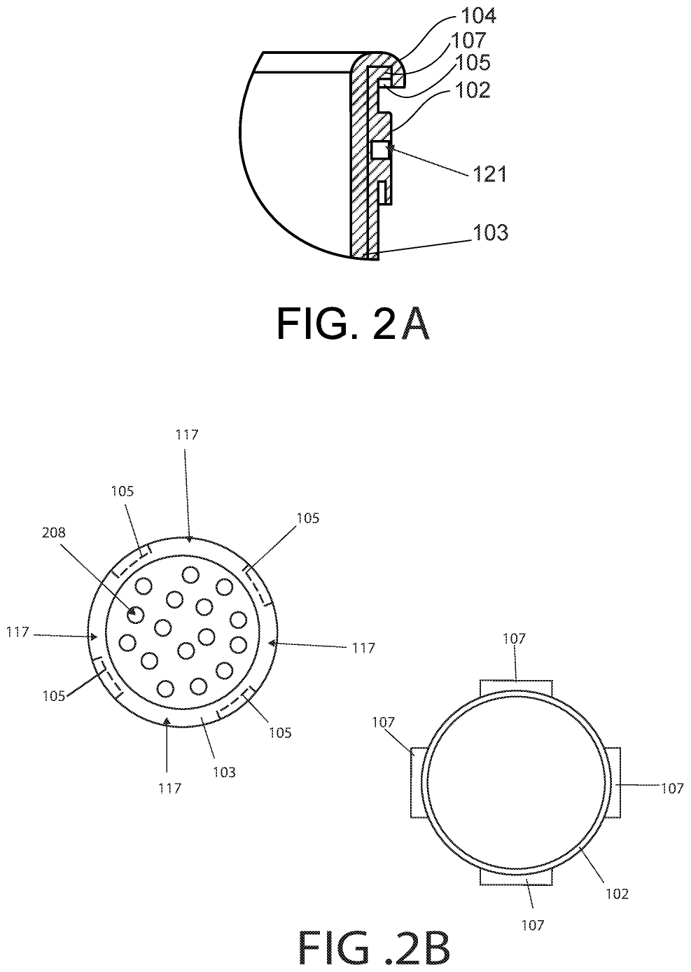

Referring to FIGS. 1-5, regarding another aspect of the disclosure, the present disclosure is further directed towards a novel irrigation system, or pod, comprising: an outer pot 102, an inner pot 103, a water inlet tube 109, a water outlet tube in, water control valves 106a and 106b, and wicking member(s) 114. The inner pot 103 comprises sidewalls 202 and a base wall, or floor, 204. In an embodiment, the floor 204 defines drain holes 208. The pots 102, 103 are optionally attachable and detachable to and from each other through a fastening mechanism, such as an interlocking ledge and shelf mechanism shown and described hereinbelow, or a snap-fit mechanism, a bolt, a screw, a magnet, or with an adhesive.

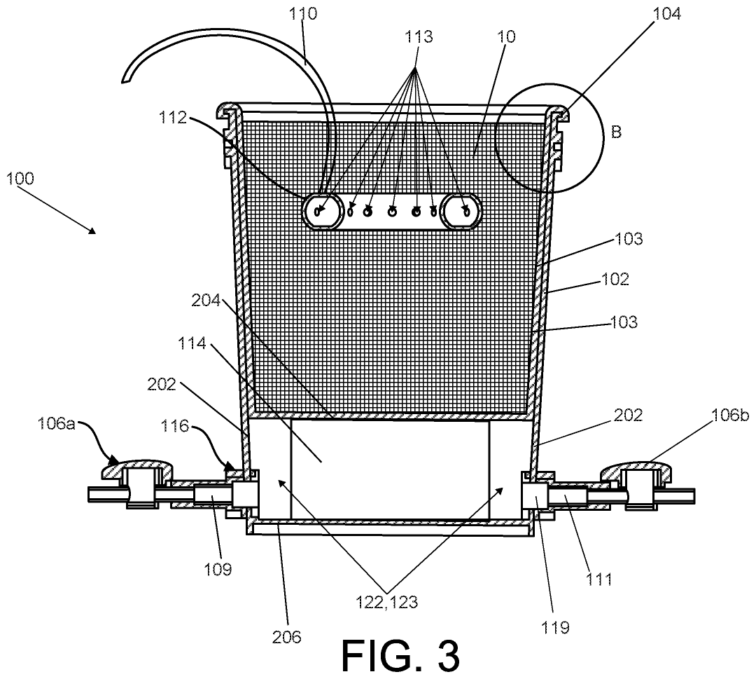

Thus, referring to FIGS. 1-10, in an example embodiment, as combined in a modular aeration and irrigation system, or pod, 100, the basic, non-plural, modular system as shown in FIG. 3 may comprise the outer pot 102 capable of being detachably interlocked with a fastening system with the inner pot 103. In this embodiment, the inner pot 103 is disposed inside the outer pot 102, and the inner pot 103 may be filled with soil and a plant or seed.

According to this embodiment, the inner pot 103 comprises a retaining portion comprising a curled upper rim 104 that creates a concave overhang that further supports an inner extension comprising a ledge, or shelf, 105 extending preferably partially around the upper periphery of the pot. The ledge 105 may comprise a plurality of ledges 105, and the ledge, or ledges, extend into the concave overhang formed by the upper rim 104 wherein the ledge, or ledges, 105 further define spaces 117 within the concave overhang area formed by the upper rim.

In this embodiment, the outer pot 102 comprises a mating upper lip 107, or plurality of lips 107, spaced around the upper peripheral rim of the pot. The lip 107, or lips 107, are spaced at opposing intervals around the periphery of the upper rim of the pot corresponding to the spaces 117 between the ledges/shelves 105 of the inner pot 103. Thus, the inner pot 103 and the outer pot 102 may be nested and detachably interlocked. This is accomplished in this embodiment by nesting the pots (outer pot 102 and inner pot 103), with the lip 107, or lips 107, of the outer pot each aligned with a space, or spaces, 109 of the inner pot, such that the lip, or lips, of the outer pot are located nestled up under the overhang of the upper rim 104 of the inner pot, and thereafter twisting one pot (e.g., outer pot 102) relative to the other pot (e.g., inner pot 103), until the lip, or lips, are supported by a corresponding ledge/shelf 105. A detent member, not shown, may be included within the upper rim 104 of the inner pot 103 to prevent one pot from being twisted too far relative to the other pot, and to lend additional structural strength to the overall detachable interconnection system.

The inner pot 103 thus positions inside the outer pot 102 in a slidable, fastenable, and detachable, relationship. In this way the pots 102, 103 may be interlocked for use in accordance with an aspect of the invention, and then detached for storage or transport to another location between uses. This ability to interlock the pots 102, 103 helps with moving and transport of the pots or otherwise handling them.

Either or both of the pots 102, 103 may have a generally cylindrical shape, as is known in the art of plant pots. However, in other embodiments, the pots 102, 103 may be square-shaped, rectangular-shaped, and annular-shaped.

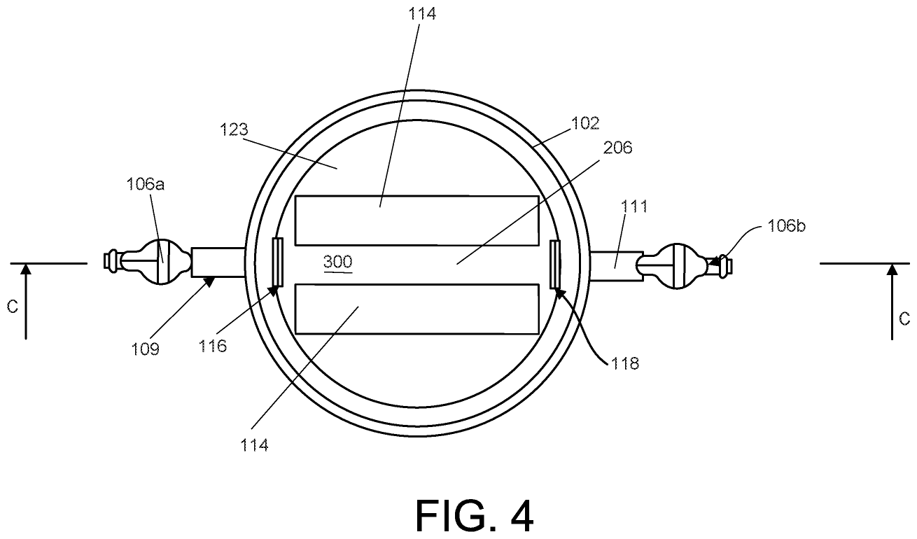

Since, in this present embodiment, the inner pot 103 is not as deep as the outer pot 102, once the two pots are nested and may be optionally interlocked (or not interlocked as shown in FIG. 4 and some of the pots of FIG. 12, there is formed a cavity, or space, 122 between and near the bottom of each of the two pots, the bottom 204 of the inner pot forming the upper portion, or ceiling, of the space, and the bottom 206 and lower sides 202 of the outer pot forming the sides and floor defining the space. A lower portion of the space 122 comprises the water and nutrient supply reservoir 123. As discussed further below, at least one wicking pad, or wicking member, 114 is positioned within the space 122 and reservoir 123.

The wicking pad 114 helps carry moisture to the soil and roots directly from the water and nutrient supply reservoir 123. In an embodiment, the wicking pad 114 comprises an outer absorbent material shell that wraps around an inner moisture retaining material with the outer absorbent material shell being sewn or tied closed around the inner moisture retaining material. Since the wicking pad 114 is disposed in the space between the outer and inner pots 102, 103 in fluid communication between the water and nutrient supply reservoir, the inner pot 103 never sets directly in the water, but on top of the wicking pad(s) 114 to keep the soil from becoming too saturated.

Due to the wicking pad 114, plants may be unattended for longer periods of time, such as even 1 to 2 weeks, before watering. The water is wicked up through the soil via the wicking pad 114, which carries the water and nutrients through the drain holes in the inner pot 103, from the water and nutrient supply reservoir 123, to the soil through capillary attraction. Thus, watering the soil from above the pots is not necessary, since the water slowly and uniformly wicks to the soil. And since water is not poured over the top of the pots, the soil stays fluffy and loose so the roots can move easily through the soil.

Because the systems 100, 200, 300 use water so efficiently by keeping it where it needs to be, the soil does not become compacted—an undesirable effect of more typical water distribution to plants. With the present invention, even in soil location climates where moderate evaporation happens, it may nevertheless be possible to leave for vacation for 2 weeks and come back to healthy plants not suffering from lack of moisture. This is because of the efficiency with which the current systems 100, 200, 300 are able to provide and conserve water irrigation and application.

In operation, the wicking pads 114 keep the soil from becoming too dry, since the wicking pad sits in the water at the bottom of the water and nutrient supply reservoir 123, and soaks up the water/nutrients at the bottom. The wicking pads 114 then hold the water in an essentially sealed reservoir (comprised of inner and outer partially nested pots 103, 102 as further described above) until the soil requires it.

Thus, the system 100 is highly efficient, and accordingly the plant requires less watering cycles per month, so less water is wasted. Further, because of the efficient on-demand nature of the irrigation system, together with the readily available oxygen supplied by the air dispersing device 112, 112′ which is connected to an air supply 108 and buried under the soil to provide air flow to the root system of the plants, the plants grow more at the speed one might expect of a hydroponics operation, but without many of the drawbacks and expense of a hydroponics system.

Because the inner pot 103 with the soil in it never directly sits in the liquid, it stays moist but never saturated. Further, the condition of the soil, whether dryer or wetter, determines when and how much water is needed in the system 100, 200, 300.

In an embodiment, the inner pot 103 may be fabricated from a cloth or porous material, and in another embodiment the inner pot may be made of plastic, or clay, with holes 208 in the bottom 204. The outer pot 102 may be fabricated from plastic, wood, metal, or clay, in order to be able to hold water.

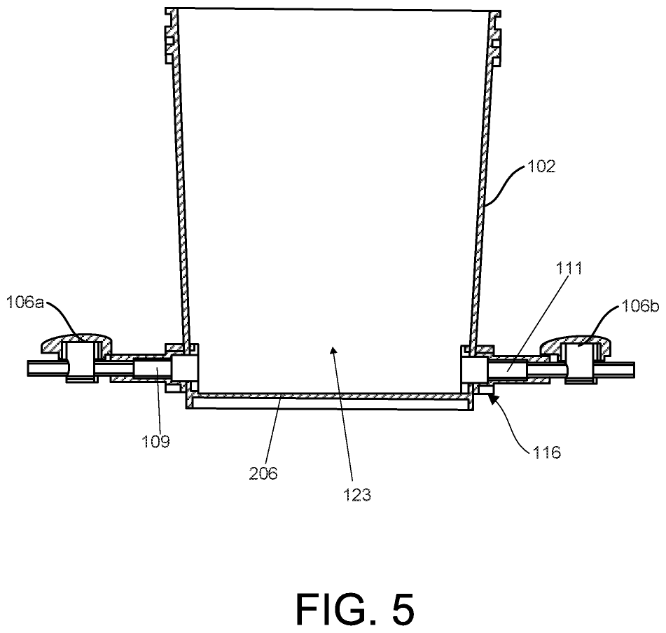

An inlet hose 109 detachably interconnects with a nozzle 116 near the bottom 206 of the outer pot 102, and preferably at a location 180° degrees diametrically opposing the nozzle 116, an outlet hose 111 detachably interconnects with another nozzle 119 near the bottom 206 of the outer pot. Each the inlet hose 109, and the outlet hose 111, preferably further comprises a valve member 106a and 106b, respectively, for selectively filling and draining the pots 102, 103. Thus, as shown in FIG. 5, preferably at least one valve 106a, 106b regulates flowage of the water through the space 122. This may include two valves 106a, 106b on opposing sides of the pots, near the bottom 206 of outer pot 102, and the valves 106a, 106b may include a butterfly valve or other commonly used valve for regulating water flow.

As water and nutrients dissolved in the water are introduced into the outer pot 102 via inlet hose 109, the water and nutrients are soaked up into the wicking pad 114 and is carried by capillary attraction upwardly toward the porous base 204 of the inner pot 103, where it will then further soak by capillary attraction into the aerated soil, and roots or seed, contained within the inner pot. In this way an optimal amount of water is provided to the roots or seed for optimal growing conditions.

The modular system 100 is unique in that multiple systems 100 can be combined to create a network of a plurality of irrigation units as shown in system 200 (see FIG. 12) or portions of modular irrigation units as shown in system 300 (see FIG. 13). Thus, individual “irrigation pods” 100 are modular and also connectible into a plural irrigation system and aeration system 200 using air tubes 110, and further with each outer pot being supplied from a pump, or gravity fed, from a shared water and nutrient supply tank 220. And, of course, it will be appreciated that a plurality of systems 100 may be implemented in a single shared irrigation tray or reservoir 240 as shown in FIG. 13.

In such a plural system 200, each separate irrigation pod can be selectively isolated with the valves 106a, 106b, and then connected or disconnected as needed. Thus, each system 100 is a modular organic style planter with a unique irrigation and aeration system that grows plants in a fraction of the time with less watering. Also, it will be appreciated by those skilled in the art that each system 100, and hence each of plural systems 200 and 300 as well, may utilize at least partially underground irrigation and aeration technology. Thus, the systems, otherwise knowns as pods, 100 can be isolated and connected together for watering purposes or disconnected from each other for relocation or any other purpose. The irrigation part of the system can be watered from a single location or over the top of the soil of each plant as is traditionally done now as used with just the aeration portion of the system.

In an embodiment, a water and nutrient supply tank 220 is disposed adjacent to the water outlet hose 11 of the outer pot, or pots, 102. Or, alternatively, the water and nutrient supply reservoir may include a reservoir 240 of water that rests beneath the pots. The water and nutrient supply tank 220, 240 allow for a controlled feeding of water and nutrients to the roots of plants.

In an embodiment, the water and nutrient supply tank 220, 240 comprises an outer shell, preferably provided with a lid, made of a hard-sturdy material, such as a 5-gallon bucket, or larger, which may be conveniently marked, either on the outside or the inside, to indicate a maximum water level.

The system 100 creates numerous advantages. Because the system 100 is a contained unit, the plants do not require as much water as used in remote locations that have limited water access such as in a desert climate. Systems 100 may also be used as community gardens in places like roof tops of apartment buildings, or abandoned lots.

Of course, adequate aeration of plants and their roots is critical to growth, and plant growth is stimulated to its highest potential when soil has a sufficient concentration of oxygen, as long as the soil stays moist. When a plant is watered from the top of a plant downwardly, the water may create a vacuum that can pull air down into the soil, but the air dispersing device 112, 112′ keeps the air concentration in the soil at high levels so the plant can breathe easier even in very saturated conditions.

As FIG. 4 shows, a bulkhead fitting 116 is provided in a hole at the junction of the inlet water hose 109 and a lower wall portion of the outer pot 102, and a bulkhead fitting 118 is also provided in another hole at the junction of the outlet water hose 111 at a preferably diametrically opposed other lower wall portion of the outer pot 102. The bulkhead fittings further comprise standard washers and fittings installed at the bottom of the outer pot 102. Further, the air tube 110 may be provided to attach to the bulkhead fitting 116 to provide isolation if needed.

In alternative embodiments of the system 100, 200, 300, an inline pump may be integrated between the pots in large gardens or nurseries. Such an inline pump would also help move the water through the system even on uneven surfaces. In other alternative embodiments, the pots may form additional drain holes that prevent the water from accumulating past a certain level; especially in outdoor environments.

In accordance with an aspect of the disclosure, a sensor could be operational on the water and nutrient supply reservoir 123, such that when the water level gets too low in the reservoir, a text may be electronically transmitted indicating that it is time to water the plants.

In other embodiments, the air dispersing device 112, 112′ may be used to pump air into a hydroponic system with the use of coupling pieces for connection instead of using a valve. Air could also conceivably be introduced in the area where the wicking pads 114 are, or underneath the wicking pads.

The irrigation pod(s) are comprised of an outer pot, or shell, and an inner pot, or shell. The outer shell is made of a hard sturdy material (such as a 5 gallon bucket). There are placed wicking pads at the bottom of the outer shell. There are bulkhead fittings installed at the bottom of the outer shell. A hose is attached to the bulkhead fittings and a valve is installed at the other end of the hose. This is to enable isolation if needed.

During installation of an embodiment, the inner pot 103 sits on top of the wicking pads 114, and the inner pot is preferably filled 2/3's of the way up with soil. The air dispersing device 112, 112′ has an air hose 110 installed into one of the holes 119 in the air dispersing device body, or shell. The air dispersing device 112 body is preferably comprised of a curved inner annular member 222, a curved outer annular member 223, a flat upper annular member 224, and flat lower annular member 225, the annular members preferably integrated into a stadium-shaped cross-section conduit member, or halves forming a hollow conduit member, forming an airway, or air conduit, 130 as shown in FIGS. 6-11B. The air dispersing device 112, 112′ is placed on the soil with the air hose 110 coming out of the air dispersing device body and covered with soil so that there is ½″ to 1.0″ of soil over the top of it.

In the embodiment of the air dispersing member 112′ shown in FIGS. 11A and 11B, the air dispersing device body is preferably comprised of a curved inner annular member 222′, a curved outer annular member 223′, a curved upper annular member 223′, and a curved lower annular member 225′, thus forming a torus-shaped, circular cross-section, air conduit.

In yet other embodiments, the air dispersing member 112, 112′ (otherwise known as a root fan) may include any hollow or porous material that has holes or can have holes put into it. The opening through holes 113 in the root fan body 112, 112′ are for air to move through the hollow space 130 and out the holes into the soil. The root fan 112, 112′ attaches to an airline 110 by connecting one end of the airline to an air supply and the other pushes through one of the holes in the body of the root fan. To accommodate different air hole and airline inlet size configurations as may be desired, a singular airline 110 hole may provided in the root fan body 112, 112′.

In setting up a network of irrigation pods 100 in a system 200, one of the reservoir hoses/valve combinations 109, 111, 206a, 206b is connected to another irrigation pod first hose/valve combination. The irrigation pod's 100 second hose/valve combination 109, 111, 206a, 206b can now be connected to other irrigation pods first hose/valve combination and so on and on. When the final irrigation pod 100 first hose/valve combination 109, 111, 206a, 206b is connected to the second hose/valve combination of the previous irrigation pod, the last irrigation pods second hose/valve combination 109, 111, 206a, 206b is connected to the reservoir's 123 second hose/valve combination to create a circuit or fully contained connection.

It is necessary to ensure that all the valves 206a, 206b are on and that preferably the wicking pads 114 are in position on either side of the irrigation tube holes so there is a canal or channel 300 running through the center of the inside of the outer pot 102 as shown in FIGS. 1 and 4—in a single pod 100 system, it would be ok for the wicking pad 114 to be oriented as shown in FIG. 3. Then, the user put's the inner pot 103, cloth pot, inside the outer pot 102, on top of the wicking pads 114, and fills the inner pot pot ⅔'s of the way full of soil.

Another step for installation involves connecting the airline 110 onto the air supply 108 and pushing the other side of the airline into one of the holes 113 in the root fan 112, 112′. The user then places the root fan 112, 112′ onto the soil and hangs the airline 110 out the top of the nested outer and inner pots 102, 103, fills the rest of the inner pot 103 (preferably a shell cloth pot) with soil covering the root fan. Another step includes placing a plant/seed in the soil above the root fan 112, 112′, and turns on the air pump 108 and fills the reservoir 123 to a fill line.

For transporting an irrigation pod 100 to another location, valves 206a and 206b are turned off, such that each pod 100 is isolated. A next step involves turning off the valve on either side of those valves belonging to other pods or the reservoir. Once the valves are shut off the user can disconnect the hose from between the shut off valves, and can move the pod away, for example for larger pots using rolling wheels (not shown) fixed to the bottom of the outer pot 102. The two loose ends of water hoses 109, 111, are then connected to each other, and the valves 206a, 206b are turned back on, so the system functions as designed.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure.

Furthermore, a variety of different other constituent module types, other than those depicted herein, can be applied to the various partitions without departing from the spirit of aspects of the invention as claimed. Additionally, with regard to flow diagrams, operational descriptions and method claims, the order in which the steps are presented herein shall not mandate that various embodiments be implemented to perform the recited functionality in exactly the same order unless the context dictates otherwise.

Thus, many modifications and other embodiments of the aspects of the invention set forth herein will come to mind to one skilled in the art to which this disclosure pertains and having the benefit of the teaching presented in the foregoing descriptions and the associated drawings. Therefore, it should be understood that the disclosure is not to be limited to the specific embodiments disclosed and that modifications and other embodiments are intended to be included within the scope of the appended claims.

What is claimed is:

1. An air dispersing member adapted for use buried in soil with an irrigation system, comprising: a hollow annular member comprising an upper annular portion, a lower annular portion, an outer annular portion, and an inner annular portion, the annular portions defining an air flow conduit within said hollow annular member, wherein at least one of said annular portions have defined therein a plurality of holes communicating between the air flow conduit to a location exterior of said hollow annular member, said hollow annular member thus being adapted to allow the passage of air into soil in which said air dispersing member has been buried by a user for aerating the soil.

2. The air dispersing member of claim 1, wherein said hollow annular member is generally torus shaped, and wherein said upper annular portion, said inner annular portion, said outer annular portion, and said inner annular portion, are each generally curved in shape, and wherein said annular portions are combined to form said generally torus-shaped air dispersing member.

3. The air dispersing member of claim 1, wherein said upper annular portion comprises a flat upper surface, said inner annular portion comprises a curved inner surface, said outer annular portion comprises a curved outer surface, and said lower annular portion comprises a flat lower surface, and wherein said annular portions are combined to form a conduit that is stadium shaped in cross-section.

4. The air dispersing member of claim 1, further comprising a plurality of said hollow annular members, each hollow annular member comprising an upper annular portion, a lower annular portion, an outer annular portion, and an inner annular portion, each hollow annular member having defined therein a plurality of holes communicating between the air flow conduit to a location exterior of each said hollow annular member, each said hollow annular member thus being further adapted to allow the passage of air into soil more closely adjacent plant roots for aerating soil and plant roots.

5. The air dispersing member of claim 4, wherein each said upper annular portion, each said inner annular portion, each said outer annular portion, and each said lower annular portion, have defined therein a plurality of holes communicating between the air flow conduit to a location exterior of said hollow annular member, each said hollow annular member thus being further adapted to allow the passage of air into soil more closely adjacent plant roots.

6. The air dispersing member of claim 1 further comprising an inlet airline connected to supply pressurized air from a source to said hollow annular member via one of said plurality of holes of said hollow annular member, and further comprising an air flow control device in line with said inlet airline.

7. A plurality of air dispersing members in accordance with claim 6, each air dispersing member further comprising an inlet airline connected via one of said plurality of holes of each said hollow annular member, each said hollow annular member adapted for being employed in a corresponding plurality of soil locations and interconnected with a common pressurized air supply via each said inlet airline.

8. An irrigation system for providing an optimal amount of water to potted plants, comprising:
a. an inner pot having a porous bottom portion and adapted for containing soil for hosting a plant or seed;
b. an outer pot adapted for containing water to a certain water level in a bottom portion of said outer pot, said inner pot adapted for residing partially nested in an upper portion of said outer pot, said inner pot and said outer pot together defining an at least partially enclosed space between the bottom portion of said inner pot and a bottom portion of said outer pot, and with the bottom portion of said inner pot adapted for being located above water level adapted to be retained in the bottom portion of said outer pot;
c. an inlet water pipe and an outlet water pipe in sealed communication with the bottom portion of said outer pot adapted for controlling the water level in the bottom portion of said outer pot; and
d. at least one wicking pad adapted to be in fluid communication between water in the bottom portion of said outer pot and the porous bottom portion of said inner pot.

9. The irrigation system of claim 8, further comprising a detachable fastening system for releasably interconnecting said inner pot and said outer pot.

10. The irrigation system of claim 9, wherein said detachable fastening system comprises an upper rim portion on said inner pot, the upper rim portion having a retaining portion and a receptacle portion, and an upper flange portion on said outer pot, the upper flange portion being adapted to be received and retained in the receptacle portion of said inner pot at one relative rotation orientation between said inner pot and said outer pot, the upper flange portion being retained in the retaining portion of the upper rim portion of said inner pot when said outer pot is twisted relative to said inner pot when the upper rim portion and the upper flange portion is engaged.

11. A plurality of irrigation systems in accordance with claim 8, each irrigation system interconnected to another irrigation system with at least a said inlet water pipe or a said outlet water pipe, for providing an optimal amount of water to a plurality of potted plants.

12. The plurality of irrigation systems of claim 11, further comprising an inlet valve on each said inlet water pipe and an outlet valve on each said outlet water pipe of each irrigation system, wherein at least one of said inlet water pipes is detachable from a water supply upline from at least one of said inlet valves, and wherein at least one of said outlet water pipes is detachable from a water outlet system downline from at least one of said outlet valves to enable transport, relocation, and subsequent interconnection of said irrigation system to another location part of the same water supply and water outlet system or another water supply and water outlet system in a manner that water is not wasted during the relocation.

13. A combination modular aeration and irrigation system adapted for providing an optimal amount of air and water to, and facilitating growth of, a potted plant, comprising:
a. an air dispersing member further comprising a hollow annular member comprising an upper annular portion, a lower annular portion, an outer annular portion, and an inner annular portion, said annular portions defining an air flow conduit within said hollow annular member, wherein at least one of said annular portions have defined therein a plurality of holes communicating between the air flow conduit to a location exterior of said hollow annular member, said hollow annular member thus being adapted to allow the passage of air into soil in which the air dispersing member has been buried by a user for aerating the soil;
b. an inlet airline connected to one of the plurality of holes of the hollow annular member adapted to supply pressurized air from a source to said air dispersing member adapted to allow passage of air into soil in which said air dispersing member has been buried by a user for aerating the soil, and further comprising an air flow control device inline with said inlet airline;
c. an inner pot having a porous bottom portion and adapted for containing soil for hosting a plant or seed;
d. an outer pot adapted for containing water to a certain water level in a bottom portion of said outer pot, said inner pot adapted for residing partially nested in an upper portion of said outer pot, said inner pot and said outer pot together defining a closed space between the bottom portion of said inner pot and a bottom portion of said outer pot, and with the bottom portion of said inner pot adapted for being located above a water level adapted to be retained in the bottom portion of said outer pot;
e. an inlet water pipe and an outlet water pipe in sealed communication with the bottom portion of said outer pot adapted for controlling the water level in the bottom portion of said outer pot; and
f. at least one wicking pad adapted to be in fluid communication between water in the bottom portion of said outer pot and the porous bottom portion of said inner pot for wicking water from said outer pot to a seed or plant in soil in said inner pot.

14. The combination modular aeration and irrigation system of claim 13, wherein each of the annular portions of said hollow annular member have defined therein a plurality of holes communicating between the air flow conduit to a location exterior of said hollow annular member, said hollow annular member thus being further adapted to allow the passage of air into soil in which the air dispersing member has been buried by a user more closely adjacent plant roots for aerating the soil and plant roots.

15. The combination modular aeration and irrigation system of claim 14, wherein each said upper annular portion, each said inner annular portion, each said outer annular portion, and each said lower annular portion have defined therein a plurality of holes communicating between the air flow conduit to a location exterior of said hollow annular member, said hollow annular member thus being further adapted to allow the passage of air into soil in which the air dispersing member has been buried by a user more closely adjacent plant roots and for aerating the soil and plant roots.

16. The combination modular aeration and irrigation system of claim 13, further comprising a detachable fastening system for releasably interconnecting said inner pot and said outer pot.

17. The combination modular aeration and irrigation system of claim 16, wherein said detachable fastening system comprises an upper rim portion on said inner pot, the upper rim portion having a retaining portion and a receptacle portion, and an upper flange portion on said outer pot, the upper flange portion being adapted to be received and retained in the receptacle portion of said inner pot at one relative rotation orientation between said inner pot and said outer pot, the upper flange portion being retained in the retaining portion of the upper rim portion of said inner pot when said outer pot is twisted relative to said inner pot with the upper rim portion and the upper flange portion being engaged.

18. A plurality of combination modular aeration and irrigation systems of claim 13 interconnected to each other for providing an optimal amount of water and aeration to a plurality of potted plants, comprising:
a. a plurality of air dispersing members further comprising a corresponding plurality of hollow annular members, each hollow annular member comprising an upper annular portion, a lower annular portion, an outer annular portion, and an inner annular portion, wherein the annular portions define a plurality of air flow conduits, each air flow conduit residing within a corresponding hollow annular member, wherein at least one of each hollow annular member has defined therein a plurality of holes communicating between the airflow conduit to a location exterior of each hollow annular member, each hollow annular member thus being adapted to allow the passage of air into soil in which each said air dispersing member has been buried by a user for aerating the soil;
b. a plurality of inlet airlines, each inlet airline connected to one of the plurality of holes of each hollow annular member and adapted to supply pressurized air from a source to each air dispersing member, further comprising an air flow control device in line with said plurality of inlet airlines;
c. a plurality of inner pots, each inner pot having a porous bottom portion adapted for containing soil for hosting a plant or seed, each hollow annular member adapted for being buried in soil in one of a corresponding plurality of inner pots;
d. a plurality of outer pots, each outer pot adapted for containing water to a certain water level in a bottom portion of each outer pot, each inner pot adapted for residing in one of a corresponding outer pot, each inner pot and corresponding outer pot adapted for residing partially nested together defining an at least partially enclosed space between the bottom portion of each inner pot and a bottom portion of each outer pot;
e. a plurality of wicking pads, each wicking pad adapted to be in fluid communication between water in the bottom portion of each outer pot and the porous bottom portion of each corresponding inner pot;
f. a plurality of inlet water pipes connected to each said of said plurality of outer pots, at least one of said inlet water pipes having an inlet valve; and
g. at least one outlet water pipe connected to one of said plurality of outer pots, said at least one outlet water pipe having an outlet valve, wherein at least one of said plurality of inlet water pipes is detachable from a water supply line and said at least one outlet water pipe is detachable from a water outlet system downline from said outlet valve, to enable transport, relocation, and subsequent interconnection of said plurality of combination modular aeration and irrigation systems to another location part of the same water supply and water outlet system or another water supply and water outlet system in a manner that water is not wasted during the relocation.

19. The plurality of combination modular aeration and irrigation systems of claim 18, wherein each inner pot and corresponding outer pot further comprises a detachable fastening system for releasably interconnecting each inner pot and corresponding outer pot.

20. The plurality of combination modular aeration and irrigation systems of claim 19, wherein each detachable fastening system comprises an upper rim portion on each inner pot, each upper rim portion having a retaining portion and a receptacle portion, and an upper flange portion on each outer pot, each upper flange portion being adapted to be received and retained in the receptacle portion of each corresponding inner pot at one relative rotation orientation between each inner pot and each corresponding outer pot, each upper flange portion being retained in the retaining portion of each corresponding upper rim portion of each corresponding inner pot when each corresponding outer pot is twisted relative to its corresponding inner pot when each upper rim portion and each corresponding upper flange portion is engaged.
